(19) United States
(12) Patent Application Publication
(10) Pub. No.: US 2008/0317652 A1
(43) Pub. Date: Dec. 25, 2008

(54) Emission control system internal to a boiler

(76) Inventors: Robert Bono, Dana-Point, CA (US); Rajashekharam V. Malyala, Camarillo, CA (US); Alec Miller, Pasadena, CA (US); Yul Kwan, Coronoa, CA (US); Stephen J. Golden, Santa Barbara, CA (US)

Correspondence Address: REED SMITH LLP, 2500 ONE LIBERTY PLACE, 1650 MARKET STREET, PHILADELPHIA, PA, 19103, US

(21) Appl. No.: 12/150,939

(22) Filed: Apr. 30, 2008

Related U.S. Application Data
(63) Continuation-in-part of application No. 11/731,570, filed on Mar. 29, 2007.
Application No. 11/731,570 is a continuation-in-part of application No. 11/651,290, filed on Jan. 9, 2007.

(51) Int. Cl. B01D 53/56

(52) U.S. Cl. 423/239.1; 422/177; 422/171

(57) ABSTRACT

This invention is an emission control system wherein the boiler hosts a reactor which contains one or more catalysts for the purpose of reducing NOₓ and/or CO in the emissions. The reactor containing the NOx/CO catalysts may be placed at a place where the temperature is in the range of 300-1000° F. The hot flue gas can be diverted using control dampers and blended with colder flue gas inside the boiler to achieve the desired flue gas temperature for the selected catalyst. NOₓ is removed by the SCR catalyst inside the boiler upon injecting a suitable reducing agent (e.g. ammonia, or hydrocarbons). The CO and NOₓ catalysts may be used in any order. The emission control system is an integral part of the boiler, and the existing capabilities of the boiler to recover the heat from flue gas, after the catalyst layers, is utilized such that the overall boiler efficiency remains high.

### RELATED APPLICATIONS

This application is a continuation-in-part of U.S. application Ser. No. 11/731,570 filed Mar. 29, 2007, which is herein incorporated by reference in its entirety and which is a continuation-in-part of U.S. application Ser. No. 11/651,290, filed Jan. 9, 2007, which is herein incorporated by reference in its entirety.

### FIELD OF THE INVENTION

Boilers are used extensively in industrial and commercial applications. Two types of boilers are used in industrial and commercial applications for the purpose of generation of steam and/or hot water. They are fire tube boilers and water tube boilers.

In a fire tube boiler, the hot flue gases (the “fire”) from the burner is channeled through tubes that are surrounded by the fluid to be heated. The body of the boiler contains the fluid to be heated. In most cases, this fluid is water that will be circulated for heating purposes or converted to steam for process use. Every set of tubes that the flue gas travels through, before it makes a turn, is considered a “pass”. So a three-pass boiler will have three sets of tubes with the stack outlet located on the rear of the boiler and the flue gas flows through the stack after it passes the 3^{rd} pass. A four-pass will have four sets and the stack outlet located after the 4^{th} pass. The temperature at the burner can be about 2500° F., and gradually decrease to 300° F. before the flue gas reaches the stack. There is space available inside the fire tube boiler between several such “passes” as the temperature gradually reduces in each pass as the flue gas heats the surrounding fluid.

A water tube boiler is the opposite of a fire tube. Here the water flows through the tubes, which are incased in a vessel through which the flue gas is discharged. These tubes are connected to a steam drum and a mud drum. The water is heated and steam is produced in the upper drum. Large steam users are better suited for the water tube design. The industrial water tube boiler typically produces steam or hot water primarily for industrial process applications, and is used less frequently for heating applications. There is space available inside the water tube boiler between the tubes that contain water.

Combustion of fossil fuels inside such boilers (if fire tube or water tube boiler is not designated, the term boiler in this specification includes both fire tube and water tube) generate harmful nitrogen oxides, carbon monoxide, unburnt hydrocarbons, sulfur oxides in addition to CO₂ and water vapor. Nitrogen oxides (NO and NO₂, referred to as “NOₓ”) are formed due to a variety of chemical reactions happening in the extremely hot sections of the boiler. CO and unburnt hydrocarbons are formed as a result of improper combustion of the fuel. A standard burner equipped in a boiler is capable of producing >100 ppm of NOₓ, while some regulations require them to be below 30 ppm in most areas world wide and below 5 ppm in highly polluted urban locations. In this specification, “polluting emissions” shall mean CO, NOₓ, unburnt hydrocarbons (“HC”) or any combination thereof.

One known way of reducing NOₓ emissions is by replacing a standard conventional burner in such boilers with a low NOₓ burner capable of achieving less than 30 ppm NOₓ or via the use of an expensive ultra low NOₓ burner capable of achieving single digit NOₓ numbers. Also known is the use of combustion related modifications as they apply to standard burners and low NOₓ burners for lowering NOₓ emissions.

Boiler/Burner manufacturers and users have gradually accepted the use of low NOₓ burners, even though they are costly, as it results in lower NOₓ emissions when compared to standard burners and to comply with emission laws at the expense of energy costs and lower boiler efficiencies. Use of a low NOₓ burners results in 30-60 ppm of NOₓ. As NOₓ regulations drive NOₓ emissions even lower, for most cases below 30 ppm and some cases below 9 ppm, the use of expensive ultra low NOₓ burners is being recommended. Table 1 presents comparison of various features of different types of burners typically used in boilers.

TABLE 1
General comparison of various features for boilers using standard,
Low NOₓ and Ultra Low NOₓ burners

| | Conventional or | Low NOₓ | Ultra Low NOₓ |
|---|---|---|---|
| Feature | Standard Burners | burners | burners |
| Flame Stability | Highly stable | Somewhat | Unstable |
| | | stable | |
| Reliability | Highly reliable | reliable | Unreliable |
| Boiler Turndown | Excellent | Good to | Poor (<4:1) |
| efficiency | (>10:1) | moderate | |
| | | (<6:1) | |
| Cost | Low | Moderate to | Expensive |
| | | high | |
| Excess O2 in flue | 1-3% | 3-5% | 3-8% |
| gas | | | |
| NOₓ in | 80-120 ppm | 30-60 ppm | <30-9 ppm with |
| flue gas | with no FGR | with 10% FGR | 25-30% FGR |
| Performance | Nameplate | Some loss of | 3-20% loss of |
| | efficiency | efficiency | nameplate |
| | | | efficiency |
| FGR with burner | None or little | 5-15% FGR | 10-35% FGR |
| Maintenance | Low | Moderate | High |
| Steam ramp rate | Fast | Good steam | Poor steam ramp |
| | | ramp rate | rate |
| Thermal | High boiler | Some loss of | Poor boiler |
| Efficiency | thermal efficiency | thermal | thermal efficiency |
| | | efficiency | |

With pollution control requirements becoming increasingly more prevalent and stringent, and concerns about both the cost of operation from energy usage, it is necessary to achieve very low NOₓ emissions without significantly decreasing the efficiency and performance of the boiler.

Known methods of combustion for reducing NOₓ emissions from combustion processes include flue gas recirculation and staged combustion. U.S. Pat. No. 4,004,875 (herein incorporated by reference) teaches a low NOₓ burner for combustion of liquid and gaseous fuels in which the combustion area is divided into at least two stages and combustion products are recirculated, cooled, and reintroduced into the primary combustion zone, resulting in a reduction of NOₓ emissions. Secondary combustion air is introduced into a secondary combustion zone downstream of the primary combustion zone in an amount sufficient to complete combustion therein. Fuel and primary combustion air are introduced into a primary combustion zone formed by a burner tile that provides a high temperature environment for the fuel and air mixture to promote combustion. Except for the opening into the secondary combustion zone, the tile is completely surrounded by a steel enclosure forming an annular space around the tile. Thus, as fuel and air are injected into the primary combustion zone, a portion of the partially combusted fuel and air is recirculated around the outside of the tile in the annular space between the tile and the steel enclosure and back into the upstream end of the primary combustion zone.

U.S. Pat. No. 6,971,336 (herein incorporated by reference) teaches a process and apparatus for combustion of gaseous and/or liquid fossil fuels which has the potential for increasing thermal efficiency and reducing NOₓ emissions from conventional heating apparatuses such as boilers and other fluid heaters, and which makes possible the use of boilers and other fluid heaters having a reduced size in comparison to conventional boilers and fluid heaters having comparable thermal ratings. More particularly, the patent relates to fire tube boilers having a plurality of combustion stages and an in-line intermediate, high-effectiveness, tubular heat exchanger extending between the combustion stages, providing for operation of a fuel-rich first combustion stage and a fuel-lean second combustion stage. Also taught in the patent was sufficient immediate cooling of the combustion products from the first combustion stage such that when the secondary combustion oxidant is added in the second combustion stage, the NOₓ formation is less than 5 ppmv on a 3%-O₂ basis. However, the gas coming out of the first section, although it has less NOₓ, it has 6 to 9% CO and similar amounts of H₂, in addition to hydrocarbons as well. No other ways of reducing harmful CO emissions have been taught in this patent except for NOₓ reduction.

Another way of reducing NOₓ emissions from boiler exhaust is by the use of a back-end post combustion emission control system using selective catalyst reduction technology. SCR is a proven post combustion technology for emission reductions for various stationary power generating equipment such as gas turbines, boilers, gas engines etc. In such a situation, an external reactor is attached between the exit breach of the boiler and the stack, or is integrated into the stack itself. Since flue gas temperatures, after exiting the boiler, can be significantly lower (about 200—about 350° F.) than the flue gas within the boiler, either a significant amount of catalyst must be used to achieve the desired NOₓ reductions, or hot flue gas, by-passed from within the boiler, must be injected in front of the catalyst layers. Use of large amount of catalyst for the purpose of NOₓ reduction is costly, and can affect overall performance of the boiler as it imposes back pressure on the boiler, thereby reducing the boiler efficiency. Injecting hot flue gas, by means of a bypass from within the reactor, results in the loss of boiler efficiency as this hotter flue gas is then emitted from the stack, with a loss of all of the associated energy of that hotter flue gas.

Traditional ammonia SCR catalysts are based on vanadia/titania. Imanari, et al. (U.S. Pat. No. 4,833,113 incorporated herein by reference), for example, describe an SCR catalyst comprising an oxide of titanium, an oxide of tungsten, and an oxide of vanadium. These catalysts require the exhaust temperature to be at about 500 to about 800° F. or more preferably at about 700 to about 800° F.

Byrne (U.S. Pat. No. 4,961,917, incorporated herein by reference) discloses a method of passing ammonia, nitrogen oxides, and oxygen over iron or copper-promoted zeolite catalysts to selectively catalyze the reduction of the nitrogen oxides. Hydrocarbons are also used for NOₓ reduction. U.S. Pat. No. 6,284,211 incorporated herein by reference teaches a method of NOₓ reduction with ethanol as a reducing agent for NOₓ reduction purposes. The suggested hydrocarbon SCR catalysts are typically silver based catalysts that are active in the temperature window of 400 to 800° F. The patent teaches ethanol as a reducing agent for lowering NOₓ emissions from exhaust gases.

The installation of some types of SCR catalyst behind industrial and commercial boilers for the purpose of NOₓ reduction has been commercialized with less than optimal results. CRI catalyst company, a division of Shell, presented a paper at the 3^{rd} international symposium on incineration and flue gas treatment technologies conducted in July 2001 in Brussels where they describe their DeNOₓ system that contains a certain SCR catalyst for the purpose of NOₓ reduction. This reactor is located downstream of the boiler, wherein the stack of the boiler is replaced or modified with a SCR reactor. Ammonia is introduced before the SCR reactor and the catalyst allows NOₓ reduction utilizing the reducing agent. One disadvantage of this system is that the temperature in the boiler stack seldom exceeds 400° F. To achieve a great degree of NOₓ reduction, significant amount of catalyst need to be used. Also when there is a lot of catalyst being used, it creates excessive back pressure due to the presence of the large SCR reactor. This is a problem because back pressure in a fire tube or a water tube boiler seldom exceeds 3 inches of water column pressure. More importantly for fire tube boilers, it is preferred to have back pressure losses around less than one inch of water column.

Also known in the art is a way of raising the temperature at the stack by mixing or blending a hot flue gas from the boiler achieved via a by-pass from the hot section of the boiler to the stack where the SCR catalyst is located. This is performed so that the hot flue gas is mixed with the colder flue gas and the mixed flue gas at the stack is at a temperature suitable for the optimum performance of the SCR catalyst. This in turn results in a waste of heat energy which would otherwise be captured by the downstream economizer in the boiler. These factors ultimately drive up the cost of installation of the SCR reactor behind such boilers.

Since SCR based catalyst technologies can remove NOₓ to single digit NOₓ values, a conventional or a standard burner can be used instead of an expensive low NOₓ or an ultra low NOₓ burner. A boiler with a standard burner will have all the benefits described in Table 1. However, standard burners result in greater NOₓ generation when compared to low NOₓ and ultra low NOₓ burners. A boiler with a conventional burner with a post control SCR system may be advantageous as it realizes all benefits of the conventional burner and results in overall lower NOₓ emissions. In such a situation, the emission control system comprises a high performance SCR catalyst arranged in layers, a reducing agent injection system upstream of the catalyst layer. However, the stack exhaust temperature of industrial and commercial boilers are significantly lower than the active temperature window of various SCR catalysts. Therefore, it is more advantageous to reap energy benefits, cost savings in addition to emissions reduction, by placing the emission reduction system inside the boiler at the optimum temperature of the SCR and/or CO catalyst as done in the present invention.

### SUMMARY OF THE INVENTION

An emission control system can be fitted or located inside a boiler at a location within the boiler where the temperature substantially matches the performance window (preferably the maximum performance window) of the SCR and/or CO catalysts for NOₓ and/or CO reduction in the flue gas, such that the heat can still be recovered. The performance window is the range of temperatures at which a certain catalyst functions (also referred to as “active”) to reduce certain emissions (e.g. without limitation NOₓ and/or CO).

The present invention uses catalyst(s) at temperatures >about 400° F. by locating the SCR catalyst inside the boiler. The catalyst is located in a reactor inside the boiler. Such an installation is expected to result in significantly lower back pressure when compared to a SCR catalyst installation after the boiler and/or in the boiler stack, while reducing noxious emissions. Also the SCR catalyst is inside the boiler, and the boiler flue gas passes through the SCR reactor, therefore no heat is lost due to the presence of an SCR catalyst inside the boiler.

SCR catalysts are defined as catalysts used for the reduction of NOx. CO catalysts are defined as catalysts used for the reduction of CO and/or unburnt hydrocarbons. The catalysts may be used with a variety of reducing agents or combination thereof (e.g. without limitation ammonia and/or hydrocarbons).

The boiler can be either a fire tube boiler or a water tube boiler which contains the reactor inside the boiler. An emission control system inside the boiler, when located in the appropriate temperature zone, can work with any type of burner. Burner types include standard or conventional burners, low NOₓ and ultra low NOₓ burners, which emits progressively lesser amounts of NOx.

Because SCR catalysts require higher temperatures than is normally the flue gas temperature discharged from most boilers in order to be active, a zone in the boiler wherein the flue gas has the temperature required for SCR catalyst activation (hereinafter all temperature references in the boiler unless otherwise noted will refer to the flue gas temperature at that location in the boiler) of sufficient volume is required. This invention describes the means in which this can either be created by design, or by modification of an existing boiler that does not have sufficient volume at the required temperature. A CO catalyst can be located either upstream or downstream of the SCR catalyst when CO removal is desired. The invention may use SCR catalysts and/or CO catalysts in any order and these catalysts may be repeated in any order (e.g. without limitation SCR catalyst, CO catalyst, and SCR catalyst).

A fire tube boiler or a water tube boiler can be fitted and/or retrofitted with a reactor comprising a SCR and/or a CO catalyst at a location inside the boiler for emission reductions.

Since the exhaust inside such fire tube and water tube boilers varies significantly before it reaches the stack, in the present invention any SCR catalyst can be used in such boilers, wherein the boiler is modified so that the reactor is in a location where the temperature is acceptable, and preferably optimum, for the catalyst to convert NOₓ and/or other compounds. This invention is not restricted to the use of a particular SCR catalyst, but in general to any catalyst capable of reducing NOₓ or other emissions via the use of a reducing agent. Reducing agent can be ammonia, ammonia generating compounds such as urea, biureate etc., or any compound capable of generating ammonia. Hydrocarbons and oxygen containing hydrocarbons can be used as reducing agents. Ethanol is an example for oxygen containing hydrocarbon.

Reducing agent injection grids or other means of introducing reducing agents are placed inside a boiler for the purpose of NOₓ reduction. The introduction point is the location where the reducing agent is introduced into the flue gas, and may be before the flue gas reaches the reactor or it may be within the reactor.

In this specification, the terms upstream and downstream refer to the location along the flue gas' path.

### FIGURES

FIG. 1 shows an embodiment of the prior art fire tube boiler.

FIG. 2 shows an embodiment of the invention with a fire tube boiler, SCR catalyst, reducing agent introduction and flow diverting baffles.

FIG. 3 shows an embodiment of the invention with a water tube boiler, SCR catalyst, and reducing agent introduction

FIG. 4 shows an embodiment of the invention mixing hot flue gas with a colder flue gas and where the hot flue gas can be used to aid the injection of the reducing agent.

### DETAILED DESCRIPTION

The invention is an emission control system comprising a boiler within which is a reactor within which is any SCR catalyst for NOₓ reduction and/or any CO catalyst for CO reduction.

In one embodiment, hot flue gas from the burner is mixed with a suitable reducing agent, then flows through the SCR catalytic bed which is inside the boiler. NOₓ in the flue gas reacts with the reducing agent in the reactor, and is converted to harmless nitrogen and water. The reducing agent may be introduced (e.g., without limitation, injected) upstream of the SCR catalyst.

In another embodiment, an ethanol SCR catalyst can be placed in the temperature window of about 715—about 815° F. inside the fire tube boiler. An ethanol SCR catalyst is defined to mean a SCR catalyst which uses ethanol as a reducing agent. In a fire tube boiler, such a temperature can be realized, for example, between the end of the second pass and the beginning of the 3 pass. The ethanol SCR catalyst along with the ethanol injection grid (which introduced ethanol into the flue gas) can be located at this temperature for overall NOₓ reduction purposes inside the fire tube boiler. In another embodiment, an ethanol SCR can be placed in the temperature window of about 715—about 815° F. inside a water tube boiler. In an embodiment, a CO catalyst can be located downstream of the Ethanol SCR catalyst in a fire tube boiler, for the purpose of CO removal.

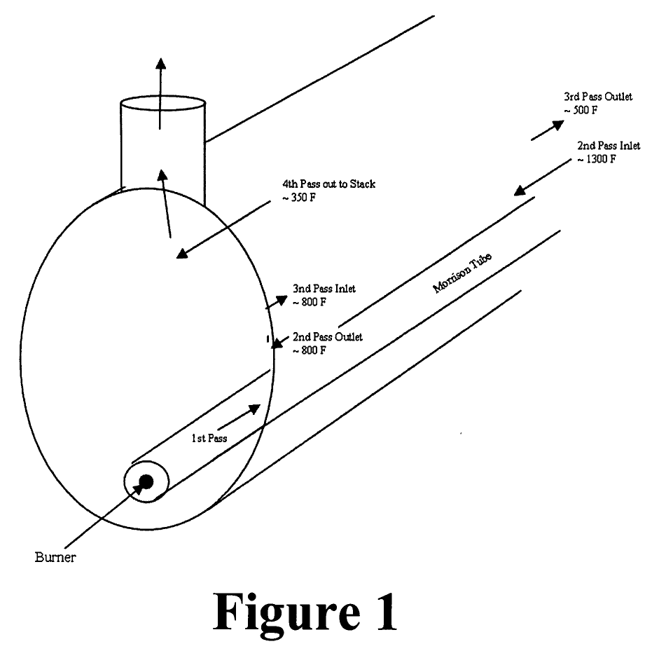

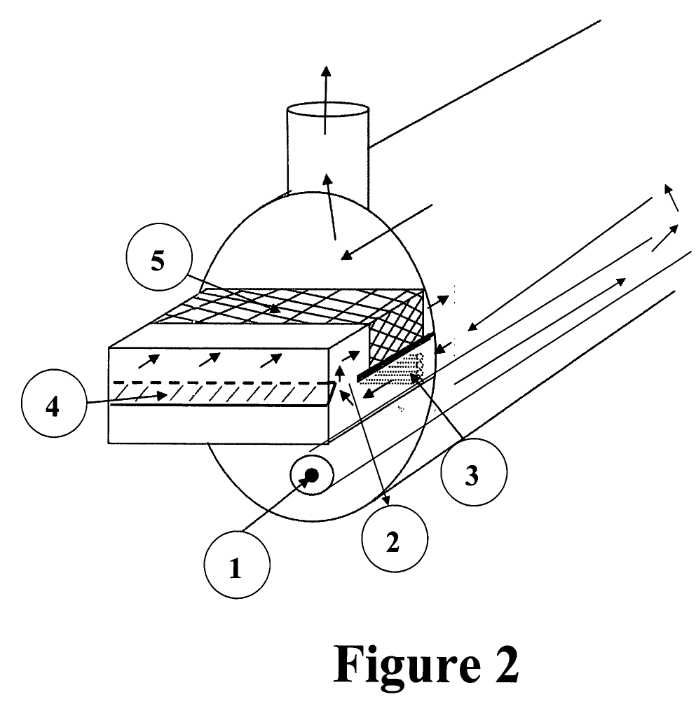

One embodiment which achieves sufficient space and temperature in a fire tube boiler is shown in FIG. 2. FIG. 1 shows a prior art fire tube boiler that has been designed with heat transfer sections that result in an exit temperature from the 2nd pass that is well suited for a SCR Catalyst performance. In FIG. 2, the burner is located at (1). The outlet of the 2^{nd} pass and the inlet of the 3^{rd} pass (2) is at a temperature of about 500—about 800° F. Reducing agent is introduced around the exit of the 2^{nd} pass (3) so that the reducing agent is mixed well with the flue gas when it reaches the SCR catalyst. Flow diverting vanes or baffles (4) are placed where the turn from the 2^{nd} pass to the 3^{rd} pass occurs. The SCR catalyst is located at the entrance of the 3^{rd} pass (5). This provides sufficient space for the reducing agent to be mixed thoroughly with the flue gas entering the reactor. The reactor is placed after the flow diverting baffles, near the entrance of the 3^{rd} pass. The arrows in FIG. 2 show the path of the flue gas.

The reducing agent can be ammonia, anhydrous ammonia, ammonia compounds, urea, biurate etc., or any compound that is capable of liberating ammonia from it. Hydrocarbons or oxygen containing hydrocarbons can be used as reducing agents. Ethanol is an example of an oxygen containing hydrocarbon that can be used as a reducing agent.

Another feature of the boilers is their turn-down feature. Depending on the steam production requirement, boilers can operate at maximum firing condition, at minimum firing condition, or any firing condition in between. For the most part the industrial and/or commercial boiler operation is carried out at varying load conditions resulting in vast differences in temperature during a boiler operation. It is this maximum and minimum firing conditions that results in vast temperature differences in the boiler exhaust. For a given amount of catalyst volume in a SCR reactor in a boiler, this means that the catalyst should operate at lower space velocities at low fire conditions and at higher space velocities at high fire conditions, where space velocity is defined as the volume of the flue gas through the SCR reactor in SCFH (standard cubic feet per hour) divided by the volume of the catalyst in cubic feet. In such a calculation, the units for space velocity are hr-1.

In another embodiment, a reactor containing the ethanol SCR catalyst can be located in this section at the entrance of the 3^{rd} pass. Upstream of this catalyst, ethanol introduction points are located so that the flue gas entering the catalytic reactor contains the reducing agent—in this case ethanol. Thus, the ethanol SCR catalyst and the ethanol introduction points are located between the outlet of the 2nd pass but before the entrance of the 3rd pass wherein the temperature is ideal for maximizing the performance of NOₓ reduction for this ethanol SCR catalyst. A similar approach can be used to locate an ammonia SCR catalyst at a temperature location where the catalyst is active, preferably most active, for reducing NOₓ using ammonia as a reducing agent.

An added benefit is that heat leaving the SCR catalyst is recaptured by downstream heat transfer surfaces in a manner typical of fire tube downstream passes. This then recaptures energy in a manner similar to that of a typical three or four pass fire tube boiler without SCR catalyst energy efficiency.

In another embodiment, the boiler may not have the temperature and space required for SCR activity in any of the several heat transfer zones. In this situation, flue gas may be diverted (via, e.g. without limitation, piping, ducting and/or control damper (used within said piping or ducting)) from a higher temperature area and mix this hotter flue gas with flue gas from a cooler location inside or outside the boiler in a ratio sufficient to achieve the desired flue gas temperature for SCR catalyst activity. For example without limitation, this hotter upstream flue gas could come from the 1st, 2nd or 3rd pass section (preferably between the 2d and 3d pass sections) and can be mixed with flue gas from to any of several downstream locations.

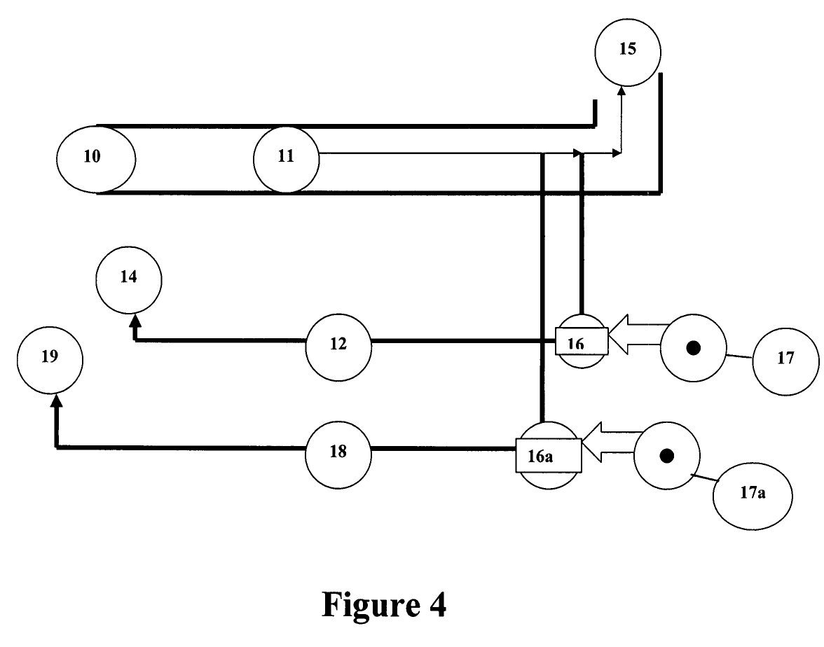

In one embodiment shown in FIG. 4, a portion of a fire tube boiler with a burner (10) is shown. Hot flue gas (meaning flue gas that is too hot for the catalyst to be active) passes from the first pass (or Morrison tube) (11) and is split into more than one section. A significant portion (preferably without limitation most) of the hot flue gas passes through the second pass (15), which may be located at the back of the boiler. Another portion of the hot flue gas (preferably without limitation greater than 1200° F.) may be piped or ducted (12) and connected to the reducing agent injection grid (14) as shown in FIG. 4. A variable frequency motor (17) to blow air, and a venturi type metal device (16), to inject and blend the hot flue gas with air may be installed in the pipe (12) that carries at least a portion of the hot flue gas to the reducing agent injection grid (14). The hot flue gas and air then go to the reducing agent injection grid (14), where reducing agents may be added. The reducing agent injection grid (14) is located upstream from the catalyst. A connection (preferably without limitation a second connection) (18) may be piped or ducted into a temperature regulation grid (19). The temperature regulation grid (19) is located upstream of the catalyst. The temperature regulation grid (19) helps regulate the temperature of the flue gas (which may be combined with air and/or reducing agents) so that the temperature is within the range for catalytic activity at the catalyst. A variable frequency motor (17a) to blow air and a venturi type metal device (16a) to inject and blend the hot flue gas with air may be installed in the pipe (18) that carries at least a portion of the hot flue gas to the temperature regulation grid (19).

In another embodiment, the hot flue gas may be mixed with colder flue gas, air and/or reducing agents to regulate its temperature into the range of catalytic activity when it reaches the catalyst.

### Fire Tube Boiler

Fire Tube Boilers have a number of sections of heat transfer surfaces designed to extract more and more heat from the combustion process as the flue gas travels sequentially from one section of heat transfer to another. In a typical three or four pass fire tube boiler: 1). A single main tube exists and sees the actual radiant energy of the burner flame (typically a large diameter corrugated style tube called a Morrison Tube) and this section is referred to as the 1st pass heat transfer section. 2). Typically the first pass is followed by a bank of tubes in which flue gas travels in a substantially opposite direction to that of the 1st pass and this bank of tubes is referred to as the 2nd pass heat transfer section. 3). A three pass fire tube boiler has an additional bank of tubes that exist downstream of the 2nd pass and in which flue gas travels in a substantially opposite direction to the 2nd pass—for the three pass fire tube boiler, flue gas exits this last and third pass to the atmosphere via a stack. 4). In a four pass fire tube boiler design yet another bank of tubes in placed after the 3rd pass in a substantially opposite direction to that of the 3rd pass, and then leaves this fourth pass of the fire tube boiler to the atmosphere via a stack. In most cases, whenever the flue gas leaves the last heat transfer section, the flue gas is no longer of sufficient temperature to employ the SCR Catalyst and/or the CO catalyst for emission reduction. Thus, the purpose of this invention is to create and house a sufficient temperature and volume space somewhere between the burner flame and the boiler discharge for the catalyst and the introduction of the reducing agent, such that the heat recovery and efficiency of the boiler remains high.

### Water Tube Boiler

In the prior art, typical exit temperatures after the flue gas passes between or among the area with the set of tubes are around 550° F. Often an economizer is used to remove excess heat from this flue gas at 550° F. Thus the flue gas reaching the stack is at a much lower temperature than 550° F., more preferably around 300-350° F.

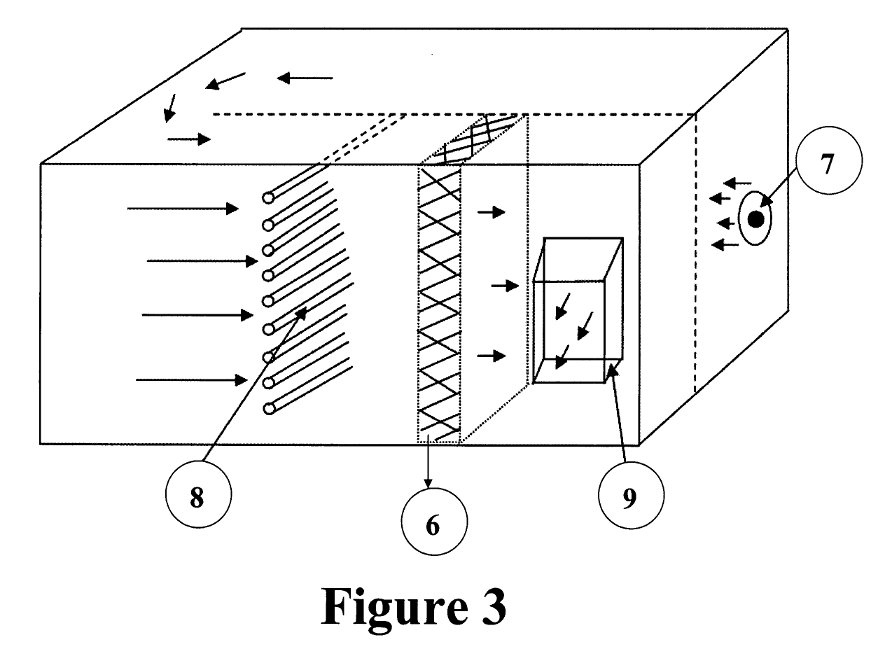

A water tube boiler may be modified to place an ethanol SCR catalyst in the temperature window of about 715—about 815° F. inside a water tube boiler. FIG. 3 shows a water tube boiler embodiment with a preferred location of the SCR catalyst and the reducing agent introduction system. In this embodiment, the burner is located at (7). The ethanol penetrates into the boiler convection section (8) where the flue gas is at about 900—about 1000° F. The reducing agent is vaporized and mixed with the flue gas and the flue gas with the reducing agent pass through the reactor (6). The treated flue gas can then pass through the boiler flue gas exit breach (9) and into the economizer for further heat recovery.

### Reactor

In a preferred embodiment, the reactor can have the SCR catalysts and/or the CO catalyst arranged in layers. The SCR and/or CO catalyst containing reactor, in a preferred embodiment, is either an integral part of the boiler shell, or is attached to the existing boiler shell in a manner so that it can be removed via a standard fastening mechanism (welding, bolting etc.). The reactor can comprise of any number of SCR catalyst and/or CO catalyst layers. For example, the catalyst layers can be suitably formed by stacking several catalyst cassettes. A catalyst cassette can be formed by bringing together several catalyst elements. The catalyst elements can be made from either ceramic or metallic. The catalyst element can be of any size or dimension. A typical catalyst element can be a six inch cube. The catalyst element can either be a coated catalyst or an extruded catalyst. The coated catalyst elements can be obtained by coating a SCR or a CO catalyst formulation on ceramic or a metal substrate. Beads and pellets may also be packed and arranged in layers, or in laminar flow reactors, or plate type arrangements.

The dimensions of the catalyst layers can be from a single catalyst element to practically anything depending on the boiler flue gas requirements and reactor space requirements, and emission reduction requirements. In an example, a catalyst cassette dimension is 1 feet wide×4 feet long×0.5 feet deep. Several catalyst cassettes can be arranged in to a catalyst layer. The catalyst layer can be surrounded with a box that forms the reactor. The dimensions of the catalyst layer are dictated by the dimensions of the reactor that is required to reduce emissions from the boiler flue gas. Although the number of catalyst layers are not limited for any boiler, for a typical boiler application, preferably 1 or 2 catalyst layers are used for NOₓ removal and 1 or 2 layers for CO removal. The catalyst cassettes and/or the catalyst layers are thus modularized for ease of installation. Also, the catalyst layer can be removed easily and stored appropriately when the boiler is not under operation. Additional layers of catalyst cassettes can be added in the future, as catalyst activity decreases over time, to extend the lifetime of the performance of the existing system, or to lower NOₓ and/or CO emissions to meet new regulatory requirements. The emission control system, which is the reactor with the reducing agent injection grid, is arranged such that the flow of the flue gas is perpendicular to the catalyst layer. The emission control system can be located either horizontally or vertically or in any direction as dictated by the application need.

### Shaped Catalyst

In an embodiment, the SCR and/or the CO catalyst inside the boiler of the present invention may be molded into a suitable shape such as a honeycomb, pellets, or beads. In another embodiment, the catalyst may be extruded into extrudates. The paste may be extruded through a die to form extrudates. The extrudates may be dried and calcined, thereby forming the catalyst. Other manners of forming shaped catalysts may also be suitable.

### Coated Catalyst

In an embodiment, the SCR and/or the CO catalyst inside the boiler of the present invention may be coated catalysts. As used herein, a substrate may be any support structure known in the art for supporting catalysts. In one embodiment of the present invention, the substrate may be in the form of beads or pellets. The beads or pellets may be formed from alumina, silica alumina, silica, titania, mixtures thereof, or any suitable material. In an exemplary embodiment of the present invention, the substrate may be a honeycomb support. The honeycomb support may be a ceramic honeycomb support or a metal honeycomb support. The ceramic honeycomb support may be formed, for example, from sillimanite, zirconia, petalite, spodumene, magnesium silicates, mullite, alumina, cordierite (Mg₂Al₄Si₅O₁₈), other alumino-silicate materials, silicon carbide, or combinations thereof. Other ceramic supports may also be suitable.

If the support is a metal honeycomb support, the metal may be a heat-resistant base metal alloy, particularly an alloy in which iron is a substantial or major component. The surface of the metal support may be oxidized at elevated temperatures above about 1000° C. to improve the corrosion resistance of the alloy by forming an oxide layer on the surface of the alloy. The oxide layer on the surface of the alloy may also enhance the adherence of a washcoat to the surface of the monolith support. Preferably, all of the substrate supports, either metallic or ceramic, offer a three-dimensional support structure.

In one embodiment of the present invention, the substrate may be a monolithic carrier having a plurality of fine, parallel flow passages extending through the monolith. The passages can be of any suitable cross-sectional shapes and sizes. The passages may be, for example, trapezoidal, rectangular, square, sinusoidal, hexagonal, oval, or circular, although other shapes are also suitable. The monolith may contain from about 9 to about 1200 or more gas inlet openings or passages per square inch of cross section, although fewer passages may be used.

The substrate can also be any suitable filter for particulates. Some suitable forms of substrates may include woven filters, particularly woven ceramic fiber filters, wire meshes, disk filters, ceramic honeycomb monoliths, ceramic or metallic foams, wall flow filters, and other suitable filters. Wall flow filters are similar to honeycomb substrates for automobile exhaust gas catalysts. They may differ from the honeycomb substrates that may be used to form normal automobile exhaust gas catalysts in that the channels of the wall flow filter may be alternately plugged at an inlet and an outlet so that the exhaust gas is forced to flow through the porous walls of the wall flow filter while traveling from the inlet to the outlet of the wall flow filter.

### Washcoat

In an embodiment, at least a portion of the SCR and/or the CO catalyst inside the boiler of the present invention may be placed on the substrate in the form of a washcoat. The term “washcoat,” as used herein, refers to a coating of oxide solids on the substrate or solid support structure. The oxide solids in the washcoat may be one or more carrier material oxides, one or more catalyst oxides, or a mixture of carrier material oxides and catalyst oxides. Carrier material oxides are porous solid oxides that may be used to provide a high surface area for a dispersed phase. Carrier materials are normally stable at high temperatures and under a range of reducing and oxidizing conditions.

In an embodiment, a washcoat may be formed on the substrate by suspending the carrier materials in water to form an aqueous slurry and placing (placing includes but is not limited to depositing, adhering, curing, applying, and spraying the aqueous slurry onto the substrate as a washcoat. In an another embodiment the washcoat may further comprise at least one inorganic oxide selected from the group consisting of alumina, silica, titania, silica-alumina, zirconia and solid solutions, composites, and mixtures thereof.

Other components such as acid or base solutions or various salts or organic compounds may be added to the aqueous slurry to adjust the rheology of the slurry. Some examples of compounds that can be used to adjust the rheology include, but are not limited to ammonium hydroxide, aluminum hydroxide, acetic acid, citric acid, tetraethylammonium hydroxide, other tetraalkylammonium salts, ammonium acetate, ammonium citrate, glycerol, commercial polymers such as polyethylene glycol, and other suitable polymers.

The slurry may be placed onto the substrate in any suitable manner. For example, the substrate may be dipped into the slurry, or the slurry may be sprayed onto the substrate. Other methods of depositing the slurry onto the substrate known to those skilled in the art may be used in alternative embodiments. If the substrate is a monolithic carrier with parallel flow passages, the washcoat may be formed on the walls of the passages. Gas flowing through the flow passages may contact the washcoat on the walls of the passages as well as materials that are supported on the washcoat.

The substrate, the washcoat, and the impregnated or ion-exchanged solution (comprising water-soluble precursor salts of the SCR and/or the CO catalyst) may be calcined to form the catalyst composition before or after the washcoat and/or the solution are added to the substrate. In an embodiment, the washcoat and the impregnated or ion-exchanged solution may be dried before calcining.

In an embodiment, the CO catalyst can be a coated catalyst and the SCR catalyst can be an extruded SCR catalyst. In another embodiment, both CO and SCR catalyst can be coated catalysts.

### Method for Removing NOₓ

The flue gas inside the boiler may be directed through or placed in contact with the reactor inside the boiler, where the reactor comprises the NOx catalyst (which may also be called “SCR catalyst”) in the presence of a reducing agent to reduce the pollutants (e.g. without limitation NOₓ and/or CO) that is contained in the flue gas. The use of NOx catalyst is required only when NOₓ abatement is necessary. The reducing agent may be introduced into the flue gas while the flue gas contacts the catalyst according to an embodiment. The reducing agent injecting device is inside the boiler and may be located upstream of the reactor or within the reactor. The flue gas and the reducing agent may be contacted with the catalyst, thereby reducing the nitrogen oxides in the flue gas. Static mixtures, flow deflecting vanes may be used to mix thoroughly the reducing agent with the flue gas inside the boiler before it reaches the SCR catalyst.

When ammonia is used a reducing agent, the ammonia/NOₓ mole ratio may be in a range of about 0.01 to about 2.5, more preferably in a range of about 0.7 to about 2, and most preferably in a range of about 0.8 to about 1.2. Low ammonia/NOₓ ratios may generally be preferred in order to minimize excess ammonia in the flue gas. Excess ammonia in the flue gas may be undesirable due to health or odor issues.

Hydrocarbons may be used as a reducing agent. Hydrocarbons may be injected into the flue gas before the SCR catalyst. Ethanol is an example of a hydrocarbon. Ethanol and the flue gas can react on the ethanol SCR catalyst for the purpose of NOₓ reduction inside the boiler.

The space velocity of the flue gas and the reducing agent passing through the SCR reactor inside the boiler may be in a range of about 1,000 hr⁻¹ to about 180,000 hr⁻¹ more preferably in a range of about 1,000 hr⁻¹ to about 90,000 hr⁻¹ and most preferably in a range of about 1,000 hr⁻¹ to about 60,000 hr⁻¹. The flue gas and the reducing agent may be contacted with the catalyst inside the boiler at a temperature of about 300° F. to about 1000° F.

### Method for Removing CO

The flue gas inside the boiler may be directed through or placed in contact with the reactor inside the boiler, where the reactor comprises either a stand-alone CO catalyst and/or a CO catalyst in combination with an SCR catalyst. The use of CO catalyst is required only when CO abatement is necessary. No reducing agent is used for CO abatement. When there is a SCR catalyst placed inside the boiler, the CO catalyst can be located either upstream or downstream of the SCR catalyst.

In one embodiment, when ammonia is used as a reducing agent to remove NOx, it is advantageous to put the CO catalyst upstream of the SCR catalyst. When ammonia is used as a reducing agent, it is even more advantageous to put the CO catalyst upstream of the ammonia introduction point (there may be multiple introduction points for a reducing agent). When hydrocarbons are used as a reducing agent, it is advantageous to put the CO catalyst downstream of the SCR catalyst.

The CO inside the boiler is expected to oxidize to carbon dioxide (CO2) by utilizing the excess O₂ in the flue gas in the presence of a CO catalyst. The CO catalyst may also convert unburnt hydrocarbons in the flue gas to CO₂ and water vapor.

The space velocity of the CO catalyst inside the boiler may be in a range of about 1,000 hr⁻¹ to about 1,000,000 hr⁻¹, more preferably in a range of about 1,000 hr to about 500,000 hr⁻¹, and most preferably in a range of about 1,000 hr⁻¹ to about 300,000 hr⁻¹. The flue gas may be contacted with the CO catalyst inside the boiler at a temperature of about 300° F. to about 1000° F. The CO catalyst can be a precious metal base catalyst or a non-precious metal based catalyst. Palladium, platinum and rhodium are defined as the precious metals.

The present invention may be embodied in other specific forms without departing from its essential characteristics. The described embodiment is to be considered in all respects only as illustrative and not as restrictive. The scope of the present invention is, therefore, indicated by the appended claims rather than by the foregoing description. All changes which come within the meaning and range of the equivalence of the claims are to be embraced within their scope.

What is claimed is:

1. A emission control system comprising
A boiler; and
A reactor located substantially inside the boiler, wherein the reactor comprises a catalyst for reducing polluting emissions from the boiler.

2. The emission control system of claim 1 wherein the catalyst comprises one or more selected from the group consisting of SCR catalyst and CO catalyst.

3. The emission control system of claim 2 wherein the catalyst comprises the SCR catalyst.

4. The emission control system of claim 2 wherein the catalyst comprises the CO catalyst.

5. The emission control system of claim 2 wherein the catalyst comprises one or more of the SCR catalyst and one or more of the CO catalyst in any order.

6. The emission control system of claim 1 further comprising one or more introduction points inside the boiler for one or more reducing agents.

7. The emission control system of claim 6 wherein the reducing agent comprises ammonia.

8. The emission control system of claim 6 wherein the reducing agent comprises one or more hydrocarbons.

9. The emission control system of claim 6 wherein the reducing agent comprises ethanol.

10. The emission control system of claim 6 wherein the reducing agent comprises ammonia and one or more hydrocarbons.

11. The emission control system of claim 1 wherein the reactor is located at a place inside the boiler wherein the place has a temperature and wherein the catalyst is active at the temperature.

12. The emission control system of claim 11 wherein the temperature is about 100° C. to about 1000° C.

13. The emission control system of claim 11 wherein the temperature is about 300° F. to about 1200° F.

14. The emission control system of claim 6 wherein the introduction points are located upstream of the reactor.

15. The emission control system of claim 6 wherein the introduction points are located inside the reactor.

16. The emission control system of claim 1 wherein the boiler comprises a fire tube boiler.

17. The emission control system of claim 16 wherein the reactor is located inside one or more passes of a fire tube.

18. The emission control system of claim 1 wherein the boiler comprises a water tube boiler.

19. The emission control system of claim 18 wherein the reactor is not located inside one or more tubes.

20. The emission control system of claim 1 further comprising a means to divert hot flue gas inside the boiler from a first place inside the boiler wherein the first place has a temperature above about 1200° F. to a second place inside the boiler wherein the second place has a second temperature below about 1200° F.

21. The emission control system of claim 20 wherein the flue gas has a temperature of about 300° F. to about 1200° F. at a third place after the second place.

22. The emission control system of claim 1 further comprising a means to mix hot flue gas and cooler flue gas inside the boiler.

23. The emission control system of claim 1 wherein the boiler uses a burner.

24. The emission control system of claim 23 wherein the burner is a standard burner.

25. The emission control system of claim 23 wherein the burner is a low NOₓ burner.

26. The emission control system of claim 23 wherein the burner is an ultra low NOₓ burner.

27. The emission control system of claim 23 wherein the burner uses a fuel.

28. The emission control system of claim 27 wherein the fuel comprises natural gas.

29. The emission control system of claim 1 wherein the catalyst comprises an extruded catalyst.

30. The emission control system of claim 1 wherein the catalyst comprises a coated catalyst.

31. The emission control system of claim 1 wherein the catalyst comprises beads.

32. The emission control system of claim 1 wherein the catalyst comprises pellets.

33. A method of reducing NOₓ comprising
Contacting a flue gas with a reactor, wherein the reactor is located within a boiler and wherein the reactor comprises a catalyst for reducing polluting emissions from the boiler.

34. The method of claim 33 further comprising introducing one or more reducing agents into the flue gas before the contacting.

35. The method of claim 33 wherein the flue gas has a temperature of about 100° C. to about 1000° C. when the contacting occurs.

36. The method of claim 33 wherein the flue gas has a temperature of about 300° F. to about 1200° F. when the contacting occurs.

37. The method of claim 33 wherein the catalyst comprises one or more selected from the group consisting of SCR catalyst, CO catalyst and combinations thereof.

38. The method of claim 37 wherein the catalyst comprises SCR catalyst.

39. The method of claim 37 wherein the catalyst comprises CO catalyst.

40. The method of claim 34 wherein the reducing agent comprises one or more selected from the group consisting of ammonia, hydrocarbons and mixtures thereof.

41. The method of claim 40 wherein the reducing agent comprises ammonia.

42. The method of claim 40 wherein the reducing agent comprises one or more hydrocarbon.

43. The method of claim 40 wherein the reducing agent comprises ethanol.
